(19) United States
(12) Patent Application Publication
(10) Pub. No.: US 2006/0126458 A1
(43) Pub. Date: Jun. 15, 2006

(54) Optical pickup head and information recording and/or reproducing device incorporating same

(75) Inventors: Wen-Hsin Sun, Tu-Cheng (TW); Ming-Chiang Tsai, Tu-Cheng (TW); Jen-Tsorng Chang, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/116,844

(22) Filed: Apr. 28, 2005

(30) Foreign Application Priority Data
Dec. 11, 2004 (TW) 93134598

(51) Int. Cl. G11B 7/00; G11B 7/135

(52) U.S. Cl. 369/44.37; 369/112.01; 369/112.28

(57) ABSTRACT

An optical pickup head (99) for an information recording and/or reproducing device is compatible with three types of optical recording media. The optical pickup head includes a first light source (12a) emitting a first beam with a first wavelength, a second light source (12b) emitting a second light beam with a second longer wavelength, a third light source (12c) emitting a third light beam with a third even longer wavelength, a photodetector (13) receiving the first, second and third beams, a prism unit (3), a collimating lens (6) for collimating the first light beams into a parallel beam, and an objective lens (8) for focusing the three light beams onto the three types of optical recording media respectively. The prism unit includes a first and a second aberration-correcting portions (440, 420) respectively for the second and third light beams to pass therethrough.

### 1. FIELD OF THE INVENTION

The present invention generally relates to an optical pickup head and an information recording and/or reproducing device using the optical pickup head, the device being able to record information on and/or reproduce recorded information from plural types of optical recording media.

### 2. PRIOR ART

Optical disks such as CDs (compact disks) and DVDs (digital versatile disks) have been used as information recording media for some time now. Recently, in order to satisfy ongoing requirements for recording and/or reproducing large quantities of information, optical disks with a memory capacity of more than 20 GB have been developed and utilized. The higher recording density of such optical disks requires that a focused spot of laser light generated by an information recording and/or reproducing device must be small and highly accurate. In general, the size of the focused spot (S) is proportional to the wavelength (λ) of the light, and inversely proportional to the numerical aperture (NA) of a lens that focuses the light, as expressed by the following formula (1):
S∝λ/NA (1)

Therefore, there is a need to construct an optical pickup head for an information recording and/or reproducing device which utilizes a short wavelength light such as blue light, and which provides a large NA. An industry-wide standard for a next generation of high density optical disks has been proposed. The standard specifies that an objective lens have an NA of 0.85, and that light beams with a wavelength of about 405 nm be used.

However, increasing the NA of an objective lens leads to sharp increases in coma aberration, a phenomenon which occurs when an optical disk is tilted. Coma aberration in turn leads to poor quality light convergence to the focused spot. Coma aberration caused by tilting of the optical disk is proportional to a thickness of an optical transmissive layer which is between a light entering plane and an information recording plane of the optical disk. Accordingly, increases in coma aberration caused by increasing the NA can be controlled by reducing the thickness of the optical transmissive layer. This approach forms the basis of a current proposal to reduce the thickness of the optical transmissive layer of next generation high density optical disks from 0.6 mm to 0.1 mm.

In using next generation high density optical disks, the first consideration is the compatibility of corresponding equipment with existing optical disks. Stated differently, a recording and/or reproducing device for next generation high density optical disks should also be capable of recording and/or reproducing data on DVDs and CDs both of which are now in widespread use. However, as indicated above, there are many differences between the two types of disks. This makes it difficult to ensure compatibility of equipment with both types of disks.

One solution to the above problem is exemplified in an optical pickup head described in U.S. Pat. No. 6,442,124. Referring to FIG. 7, the optical pickup head (not labeled) includes three light sources 83 that radiate three light beams having different wavelengths. A dichroic beam splitter 81 includes three input surfaces (not labeled) receiving light beams from the light sources 83 respectively, and an output surface (not labeled). Each input surface is formed on a side of the dichroic beam splitter 81, and each of the light sources 83 is opposite to the corresponding input surface. A converging device 82 is arranged in a light path between the dichroic beam splitter 81 and an optical disk (not labeled). The converging device 82 includes two objective lenses 82a and 82b having different numerical apertures specified by different optical disk formats. The optical pickup head also includes a switching machine to switch the two objective lenses 82a and 82b, so as to enable the corresponding objective lens to be located on the light path when recording and/or reproducing information on/from the optical disk. The light beams reflected from the optical disk are received by three photodetectors 84 through the dichroic beam splitter 50 and three hologram elements 85, each photodetector 84 being juxtaposed with one corresponding light source 83.

The above-described optical pickup head uses two objective lenses 82a and 82b corresponding to different optical formats. This makes the recording and/or reproducing device unduly costly. In addition, the switching machine makes the optical pickup head complex and costly. Furthermore, the three light sources 83 and the three photodetectors 84 are positioned on different sides of the dichroic beam splitter 81, which makes the optical pickup head unduly largely. Moreover, the light beams emitted from the light sources 83 are divergent. When the divergent light beams are directly focused toward the optical disk to form a focused spot, the focused spot is usually large, and aberrations in the light beams occur. This in turn leads to poor quality performance of the optical pickup head.

To solve the aforementioned problems, an improved optical pickup head compatible with DVDs and CDs has been developed. The optical pickup head includes a semiconductor laser device, a collimating lens, and an objective lens. The semiconductor laser device integrates two semiconductor lasers with different wavelengths and two detectors on a same substrate. The semiconductor lasers and the detectors are juxtaposed in a line. The semiconductor lasers are used for emitting laser beams for a CD and a DVD, respectively. In addition, the substrate is disposed inside a case and is sealed with a hologram element. Two diffraction gratings are formed on the hologram element, each diffracting grating being opposite to a corresponding pair of a semiconductor laser and a detector. A composite prism is disposed beside the two diffraction gratings. The prism includes a reflecting mirror, and a wavelength deflection filter parallel to the reflecting mirror.

When recording and/or reproducing information with respect to the CD, a laser beam with a wavelength of 780 nm is emitted from one of the semiconductor lasers. The laser beam passes through the corresponding diffraction grating formed on the hologram element, and enters the composite prism. In the composite prism, the laser beam is reflected by the reflecting mirror and the wavelength deflection filter in turn, and propagates out from the composite prism. After exiting the composite prism, the laser beam is converted into a parallel beam by the collimating lens, and is then focused on the CD by the objective lens. The laser beam reflected by the CD passes through the objective lens, the collimating lens, the prism, the corresponding diffraction grating, and is received by the detector beside the semiconductor laser which emitted the laser beam.

When recording and/or reproducing information with respect to the DVD, a laser beam with a wavelength of 650 nm is emitted from the other semiconductor laser. The laser beam passes through the corresponding diffraction grating and the wavelength deflection filter of the composite prism, and is converted into a parallel beam by the collimating lens. The parallel beam is converged by the objective lens and focused on the DVD. The laser beam reflected by the DVD passes through the objective lens, the collimating lens, the composite prism, the corresponding diffraction grating, and is received by the other detector.

This type of optical pickup head reduces the number of optical components and simplifies the overall configuration to a certain extent. However, there is a continuing demand for optical pickup heads of recording and/or reproducing devices to be even further miniaturized. In addition, the optical performance of the optical pickup head is limited. Because there is only the single common objective lens and the single collimating lens focusing light having the two different wavelengths, the focusing of the light of one of these wavelengths is subject to chromatic aberration. Furthermore, the two types of disks have different thicknesses, including different thicknesses of light transmission layers thereof. Therefore the focusing of the light of either or both wavelengths is subject to spherical aberration. These problems in turn lead to poor quality light convergence to the focused light spot.

### SUMMARY OF THE INVENTION

Accordingly, an object of the present invention is to provide an optical pickup head for an information recording and/or reproducing device compatible with three types of optical disks, in which optical aberrations are corrected and a size of the optical pickup head is reduced.

Another object of the present invention is to provide an information recording and/or reproducing device using the above-described optical pickup head.

To achieve the first above-mentioned object, an optical pickup head for an information recording and/or reproducing device compatible with three types of optical recording media is provided. The optical pickup head includes a first light source emitting a first beam with a first wavelength, a second light source emitting a second light beam with a second wavelength greater than the first wavelength, a third light source emitting third light beams with a third wavelength greater than the second wavelength, a receiving member receiving the first, second and third light beams, a prism unit, a collimating lens for collimating at least one of the first, second and third light beams into a parallel beam, and an objective lens for receiving the first, second and third light beams and focusing them onto the three types of optical recording media respectively. The prism unit includes a first portion for transmitting the first light beam emitted from the first light source, a second portion for transmitting the second beam emitted from the second light source, a third portion for transmitting the third light beam emitted from the third light source, a fourth portion for transmitting all of the first, second and third light beams, a first aberration-correcting portion for the second light beams to pass therethrough, and a second aberration-correcting portion for the third light beams to pass therethrough.

To achieve the second above-mentioned object, an information recording and/or reproducing device includes an optical pickup head as described in the above paragraph, a drive mechanism for changing a relative position between an information storage medium and the optical pickup head, and an electrical signal processor for receiving signals output from the optical pickup head and performing calculations to obtain desired information.

Other objects, advantages and novel features of the present invention will be drawn from the following detailed description of preferred embodiments thereof with the attached drawings, in which:

### BRIEF DESCRIPTION OF THE DRAWINGS

FIG. 1 is an exploded, isometric view of an arrangement of parts of an optical pickup head according to a preferred embodiment of the present invention, showing essential optical paths thereof;

FIG. 2 is an enlarged isometric view of a semiconductor module of the optical pickup head of FIG. 1;

FIG. 3 is an enlarged isometric view of a prism unit of the optical pickup head of FIG. 1;

FIG. 4 is a view of a wavelength selector of the optical pickup head shown in FIG. 1, showing transmission characteristics of various portions of the wavelength selector;

FIG. 5 is essentially an exploded, top plan view of parts of the optical pickup head of FIG. 1 relating to first and second light beams thereof, and showing essential optical paths of the first and second light beams;

FIG. 6 is essentially an exploded, side plan view of parts of the optical pickup head of FIG. 1 relating to a third light beam thereof, and showing essential optical paths of the third light beam; and

FIG. 7 is a schematic view of an arrangement of parts of a conventional optical pickup head, showing essential optical paths thereof.

### DETAILED DESCRIPTION OF THE INVENTION

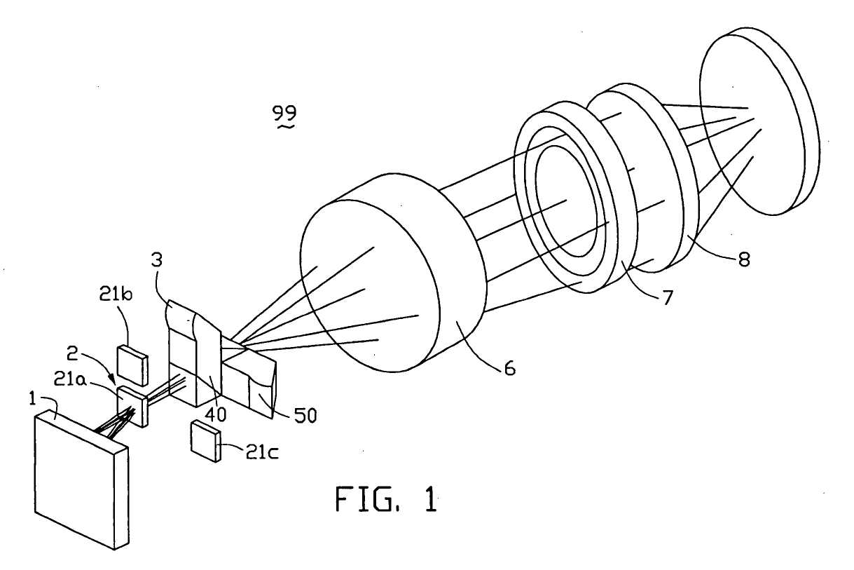

Referring to FIG. 1, an optical pickup head 99 according to the preferred embodiment of the present invention is illustrated. The optical pickup head is typically used in an information recording and/or reproducing device compatible with three types of optical recording media (not labeled). In this description, the three types of optical recording media respectively are high density optical disks such as BDs (Blu-ray disks) or HD-DVDs (High Definition-Digital Versatile Disks), DVDs, and CDs.

The optical pickup head 99 includes a semiconductor module 1, a hologram unit 2 opposite to the semiconductor module 1, a prism unit 3 located next to the hologram unit 2, a collimating lens 6, an objective lens 8 located on an optical axis defined by the collimating lens 6, and a wavelength selector 7 located on an light path between the collimating lens 6 and the objective lens 8.

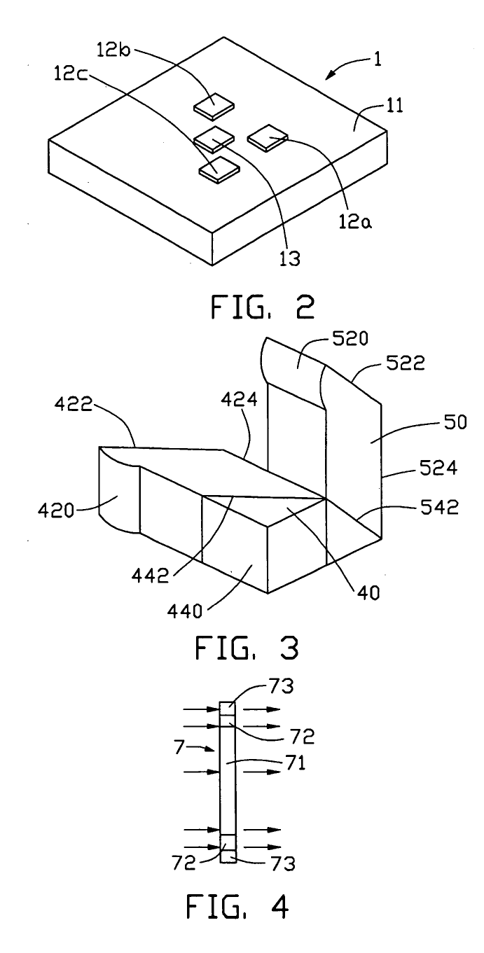

Also referring to FIG. 2, the semiconductor module 1 integrates three lasers 12a, 12b and 12c and a photodetector 13 as a receiving member on a same planar substrate 11. The three lasers 12a, 12b and 12c emit three laser beams with different wavelengths to be employed as irradiation light beams. A first light beam from the first laser 12a has a shortest wavelength such as about 405 nm. A second light beam from the second laser 12b has an intermediate wavelength such as 650 nm. A third light beam from the third laser 12c has a longest wavelength such as 780 nm. The first, second and third light beams transmit to the corresponding optical disks, and are received by the photodetector 13 after being reflected by the optical disks. These reflected first, second and third light beams are referred to as first, second and third return light beams.

The optical pickup head 99 also includes a cover (not shown). The cover covers the substrate 11 and seals the first, second and third lasers 12a, 12b and 12c and the photodetector 13 therein. The hologram unit 2 is positioned on a top side of the cover, and includes three hologram elements 21a, 21b and 21c. The three hologram elements 21a, 21b and 21c are positioned opposite to the corresponding lasers 12a, 12b and 12c, respectively. Therefore, the first, second and third light beams entering first sides of the hologram elements 21a, 21b and 21c can pass therethrough along their original directions. The first, second and third return light beams entering opposite second sides of the hologram elements 21a, 21b and 21c are deviated thereby. The first, second and third hologram elements 21a, 21b and 21c respectively have special characteristics such as predetermined pitches and locations, so as to enable the first, second and third return light beams deviated by them to have a same focus. The photodetector 13 is located at this focus. That is, only a single element is needed to receive the three light beams irradiating from different directions. In order to minimize the size of the semiconductor module 1, the photodetector 13 is located among a pattern defined by connecting lines of the three lasers 12a, 12b and 12c.

Also referring to FIG. 3, the prism unit 3 includes a first and a second prisms 40 and 50, which are perpendicularly attached to each other. The first prism 40 includes a first incident portion 440 and a second incident portion 420. The first and second incident portions 440, 420 are located at opposite ends of a same side of the first prism 40. The first incident portion 440 is planar, and faces the first laser 12a so as to receive the first light beam emitted from the first laser 12a. The second incident portion 420 is spherical or aspherical, so as to correct aberrations along a light path from the second laser 12b to the corresponding optical disk. The first prism 40 also includes a first emergent portion 424 generally parallel to the first and second incident portions 440 and 420, a first reflective surface 422 interconnecting the second incident portion 420 and the first emergent portion 424 at corresponding ends thereof, and a first splitting plane 442 parallel to the first reflective surface 422 at an opposite side of the first prism 40. The first splitting plane 442 allows incident light beams with a certain wavelength to pass therethrough, and reflects incident beams with other wavelengths.

The second prism 50 includes a main incident portion (not labeled) abutting the first emergent portion 424 of the first prism 40, and a third incident portion 520 juxtaposed with the main incident portion at an end of the second prism 50. The third incident portion 520 is spherical or aspherical, so as to correct aberrations along a light path from the third laser 12c to the corresponding optical disk. The second prism 50 also includes a second emergent portion 524 that is generally parallel to the third incident portion 520 and the main incident portion, a second reflective surface 522 interconnecting the third incident portion 520 and the second emergent portion 524 at corresponding ends thereof, and a second splitting plane 542 parallel to the second reflective surface 522 at an opposite side of the second prism 50.

The collimating lens 6 is positioned beside the prism unit 3, and has optical characteristics according with the wavelength of the first light beam, so as to converge the first light beam into a completely parallel light beam, and converge the second and third light beams into approximately parallel light beams. The objective lens 8 faces the optical disk, and has optical characteristics according with the wavelength of the first light beam, so as to focus the first parallel light beam on the optical disk without any aberration. Further, the objective lens 8 also has a large numerical aperture, which is specified by the high density optical disk corresponding to the first light beam. The wavelength selector 7 is located adjacent the objective lens 8, to selectively transmit incident light beams thereto.

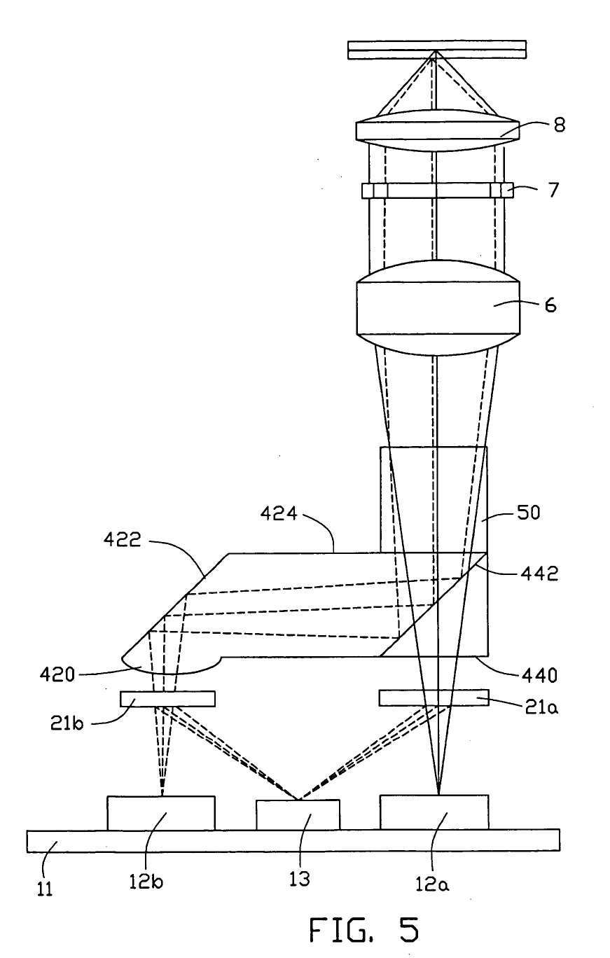

Referring to FIG. 4, the wavelength selector 7 includes a central portion 71, a middle portion 72 encircling the central portion 71, and a peripheral portion 73 encircling the middle portion 72. The three portions 71, 72 and 73 have different transmission functions. With regard to the central portion 71, light beams with any wavelength can pass therethrough. With regard to the middle portion 72, light beams with the first and second wavelengths can pass therethrough, and light beams with the third wavelength are blocked. With regard to the peripheral portion 73, only light beams with the first wavelength can pass therethrough, and light beams with the second and second wavelengths are blocked. Therefore, the effective NA of the objective lens 8 is different when focusing the light beams with different wavelengths.

Referring to FIG. 3 and FIG. 5, when recording an information signal on and/or reproducing an information signal from a high density optical disk, the first laser 12a emits a first light beam with the wavelength of 405 nm. The first light beam passes through the first hologram element 21a along its original direction, and enters the first prism 40 through the first incident portion 440. In the first prism 40, the first light beam passes directly through the first splitting plane 442 because of its wavelength, and transmits out from the first emergent portion 424. After exiting the first prism 40, the first light beam enters the second prism 50 through the main incident portion, and propagates to the second splitting plane 542. The first light beam passes directly through the second splitting plane 542 because of its wavelength, and transmits out from the second emergent portion 524.

After exiting the prism unit 3, the first light beam is condensed by the collimating lens 6 and transformed into a first parallel light beam. The first parallel light beam transmits to the wavelength selector 7, and passes through the wavelength selector 7 without any blocking by the portions 71, 72 and 73 thereof. Then the first parallel light beam illuminates the objective lens 60. The objective lens 60 focuses the first parallel light beam toward the optical disk to form a focused laser spot (not shown) on an information recording layer (not labeled) of the high density optical disk.

When the focused laser spot is formed on the high density optical disk, the high density optical disk reflects the first light beam as a first return light beam including recorded information. The first return light beam sequentially passes through the objective lens 8, the wavelength selector 7, the collimating lens 6 and the prism unit 3, and reaches the first hologram element 21a. The first return light beam is deviated by the first hologram element 21a, and is received by the photodetector 13. The photodetector 13 translates the first return light beam into electrical signals, which are output from the optical pickup head 99. An electrical signal processor (not shown) of the information recording and/or reproducing device receives the electrical signals output from the optical pickup head 99, and performs calculations to obtain the desired information. Furthermore, a drive mechanism (not shown) of the information recording and/or reproducing device changes a relative position between the high density optical disk and the optical pickup head 99, also based on the electrical signals output from the optical pickup head 99.

When recording an information signal on and/or reproducing an information signal from a DVD, the second laser 12b emits a second light beam (not labeled) with the wavelength of 650 nm. The second light beam passes through the second hologram element 21b along its original direction, and enters the first prism 40 through the second incident portion 420. The second light beam is condensed to a certain extent by the second incident portion 420. The second light beam is reflected by the first reflective surface 422, and propagates to the first splitting plane 442. The first splitting plane 442 reflects the second light beam because of its wavelength, and the second light beam transmits out from the first emergent portion 424. Then, the second light beam enters the second prism 50 through the main incident portion. In the second prism 50, the second light beam propagates to the second splitting plane 542, passes directly through the second splitting plane 542 because of its wavelength, and transmits out from the second emergent portion 524.

After exiting the prism unit 3, the second condensed light beam is further converged by the collimating lens 6 and transformed into a second approximately parallel light beam. The second approximately parallel light beam transmits to the wavelength selector 7. Only a part of the second approximately parallel light beam which illuminates the central portion 71 and middle portion 72 passes therethrough, whereas the other part of the second approximately parallel light beam which illuminates the peripheral portion 73 is blocked. The passed second light beam is incident on the objective lens 8, and is focused toward the DVD so as to form a focused laser spot (not labeled) on an information recording layer (not labeled) of the DVD.

When the focused laser spot is formed on the DVD, the DVD reflects the second light beam as a second return light beam (not labeled) including recorded information. The second return light beam sequentially passes through the objective lens 8, the wavelength selector 7, the collimating lens 6 and the prism unit 3, and reaches the second hologram element 21b. The second return light beam is deviated by the second hologram element 21b, and is received by the photodetector 13. The photodetector 13 translates the second return light beam into electrical signals, which are output from the optical pickup head 99. The electrical signal processor receives electrical signals output from the optical pickup head 99, and performs calculations to obtain the desired information. Furthermore, the drive mechanism changes a relative position between the DVD and the optical pickup head 99, also based on electrical signals output from the optical pickup head 99.

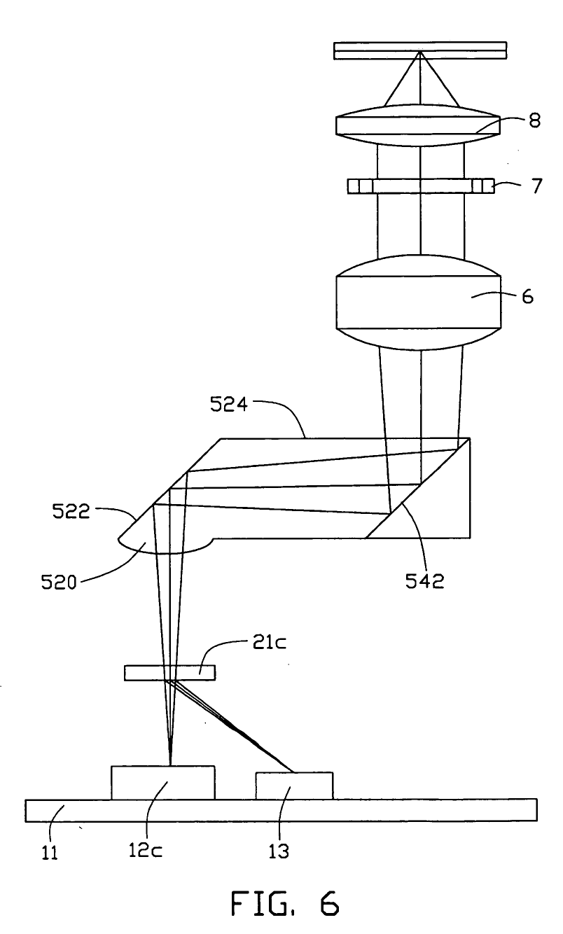

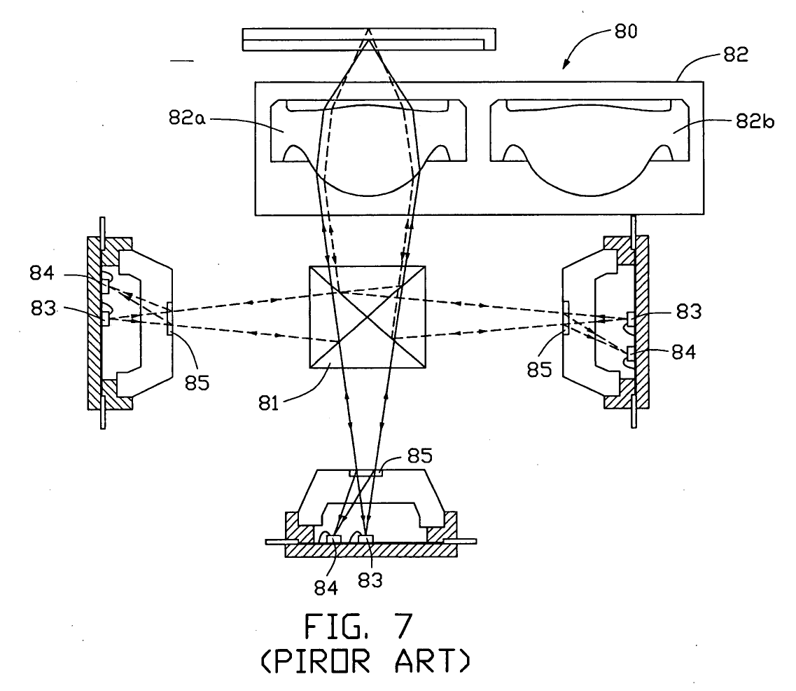

Referring to FIG. 6, when recording an information signal on and/or reproducing an information signal from a CD, the third laser 12c emits a third light beam with the wavelength of 780 nm. The third light beam passes through the third hologram element 21c along its original direction, and transmits to the second prism 50. The third light beam is condensed to a certain extent by the third incident portion 520, and enters the second prism 50. In the second prism 50, the third light beam is sequentially reflected by the second reflective surface 522 and the second splitting plane 542, and transmits out from the second emergent portion 524. After exiting the second prism 50, the third light beam is converged further by the collimating lens 6, and transformed into a third approximately parallel light beam. The third approximately parallel light beam transmits to the wavelength selector 7. Only part of the third approximately parallel light beam which illuminates the central portion 71 passes therethrough, whereas another part of the third approximately parallel light beam which illuminates the middle portion 72 and the peripheral portion 73 is blocked. The passed third light beam is incident on the objective lens 8, and is focused toward the CD so as to form a focused laser spot (not shown) on an information recording layer (not shown) of the CD.

When the focused laser spot is formed on the CD, the CD reflects the third light beam as a third return light beam including recorded information. The third return light beam sequentially passes through the objective lens 8, the wavelength selector 7, the collimating lens 6 and the prism unit 3, and reaches the third hologram element 21c. The third return light beam is deviated by the third hologram element 21c, and is received by the photodetector 13. The photodetector 13 translates the third return light beams into electrical signals, which are output from the optical pickup head 99. The electrical signal processor receives electrical signals output from the optical pickup head 99, and performs calculations to obtain the desired information. Furthermore, the drive mechanism changes a relative position between the CD and the optical pickup head 99, also based on the electrical signals output from the optical pickup head 99.

The optical pickup head 99 provides good performance for all three kinds of optical disks. Both (i) the working wavelength of optical components, such as the first laser 12a, the collimating lens 6 and the objective lens 8, and (ii) the numerical aperture of the objective lens 8, are matched with requirements of the high density optical disk. Therefore, when recording the information signal on and/or reproducing the information signal from the high density optical disk, the optical pickup head 99 has high quality light convergence to the focused spot. Furthermore, the first prism 40 has a spherical or an aspherical surface at the second incident portion 420. Therefore, aberrations caused by non-matching between the second light beam and the collimating lens 5 and objective lens 7 are corrected. Similarly, the second prism 50 has a spherical or aspherical surface at the third incident portion 520. Therefore aberrations caused by non-matching between the third light beam and the collimating lens 6 and objective lens 8 are corrected. Moreover, the wavelength selector 7 selects a part of the light beams with wavelengths of 650 nm and 780 nm transmitting to the objective lens 7, so that only a part of the objective lens 8 can be illuminated. Thus, the NA of the objective lens 8 is reduced when focusing the second or third light beams, and corresponds to the small NA required by the DVD and CD respectively. Hence, when recording the information signal on and/or reproducing the information signal from the DVD and the CD, the optical pickup head 99 also has high quality light convergence to the focused spot.

The optical pickup head 99 also has structural and other advantages. Because the second and third light beams are reflected by the surfaces of the prism unit 3, the distances between the collimating lens 6 and the second and third lasers 12b and 12c are reduced. This enables the optical pickup head 99 to be miniaturized. In addition, the spherical/aspherical surfaces are directly formed on the first and second prisms 40 and 50, so that no extra optical element or elements need be added to the optical pickup head 99. This further facilitates miniaturization of the optical pickup head 99, and improves the efficiency of production.

Furthermore, the three hologram elements 21a, 21b and 21c deviate the three return light beams from different directions onto the same location. Therefore, only a single photodetector 13 is needed to receive all thereturn light beams. Moreover, the three lasers 12a, 12b and 12c and the photodetector 13 are integrated on the same substrate 11. These advantages further facilitate miniaturization of the optical pickup head 99, savings in costs, and enhanced efficiency of mass production.

Although the present invention has been described with reference to a specific embodiment, it should be noted that the described embodiment is not necessarily exclusive, and that various changes and modifications may be made to the described embodiment without departing from the scope of the invention as defined by the appended claims.

What is claimed is:

1. An optical pickup head for an information recording and/or reproducing device compatible with three types of optical recording media, comprising:
a first light source emitting a first beam with a first wavelength;
a second light source emitting a second light beam with a second wavelength greater than the first wavelength;
a third light source emitting a third light beam with a third wavelength greater than the second wavelength;
a receiving member receiving the first, second and third light beams;
a prism unit including a first portion for transmitting the first light beam emitted from the first light source, a second portion for transmitting the second beam emitted from the second light source, a third portion for transmitting the third light beam emitted from the third light source, and a fourth portion for transmitting all of the first, second and third light beams;
a collimating lens for collimating at least one of the first, second and third light beams into a parallel beam; and
an objective lens for receiving the first, second and third light beams and focusing them onto the three types of optical recording media respectively;
wherein, the prism unit further includes a first aberration-correcting portion for the second light beams to pass therethrough, and a second aberration-correcting portion for the third light beams to pass therethrough.

2. The optical pickup head according to claim 1, wherein at least one of the first and second aberration-correcting portions is an aspherical surface.

3. The optical pickup head according to claim 1, wherein at least one of the first and second aberration-correcting portions is a spherical surface.

4. The optical pickup head according to claim 1, wherein the prism unit comprises a first prism and a second prism, the first portion and second portion are formed on a same side of the first prism, and the third portion and fourth portion are formed on two opposite sides of the second prism.

5. The optical pickup head according to claim 4, wherein the first aberration-correcting portion is provided at the second portion, and the second aberration-correcting portion is provided at the third portion.

6. The optical pickup head according to claim 4, wherein the first prism and second prism are perpendicular to each other.

7. The optical pickup head according to claim 6, wherein first and second light beams output from the first prism enter the second prism through a portion thereof which is juxtaposed with the third portion.

8. The optical pickup head according to claim 1, further comprising a hologram unit for deviating the first, second and third light beams reflected by the corresponding optical recording media onto the receiving member.

9. The optical pickup head according to claim 8, wherein the receiving member is a photodetector, and the hologram unit includes three hologram elements corresponding to the first, second and third light sources respectively.

10. The optical pickup head according to claim 9, wherein the photodetector is integrated with first, second and third light sources.

11. The optical pickup head according to claim 10, wherein the photodetector is located among a pattern defined by the first, second and third light sources.

12. The optical pickup head according to claim 1, wherein the objective lens has a numerical aperture specified by one of the three types of optical recording media, being that which has the highest recording density.

13. The optical pickup head according to claim 12, further comprising a wavelength selector located between the collimating lens and the objective lens, for selectively passing a portion of the second and third light beams.

14. An information recording and reproducing apparatus compatible with at least first, second and third optical recording media, comprising:
an optical pickup head, comprising:
a first light source emitting a first light beam with a first wavelength;
a second light source emitting a second light beam with a second wavelength greater than the first wavelength;
a third light source emitting a third light beam with a third wavelength greater than the second wavelength;
a receiving member receiving the first, second and third light beams;
a prism unit including a first portion for transmitting the first light beam emitted from the first light source, a second portion for transmitting the second beam emitted from the second light source, a third portion for transmitting the third light beam emitted from the third light source, and a fourth portion for transmitting all of the first, second and third light beams;
a collimating lens for collimating at least one of the first, second and third light beams into a parallel beam; and
an objective lens for receiving the first, second and third light beams and focusing them onto the at least first, second and third optical recording media respectively;
wherein, the prism unit further comprises a first aberration-correcting portion for the second light beams to pass therethrough, and a second aberration-correcting portion for the third light beams to pass therethrough;
a drive mechanism for changing a relative position between any one of the at least first, second and third optical recording media and the optical pickup head; and
an electrical signal processor for receiving signals output from the optical pickup head and performing calculations to obtain desired information.

15. The information recording and reproducing apparatus according to claim 14, wherein at least one of the first and second aberration-correcting portions is an aspherical surface.

16. The information recording and reproducing apparatus according to claim 14, wherein at least one of the first and second aberration-correcting portions is a spherical surface.

17. An information recording and reproducing apparatus compatible with three types of optical recording media, comprising:
a first light source emitting first light beams with a first wavelength for one of said three types of optical recording media;
a second light source emitting second light beams with a second wavelength greater than said first wavelength for another of said three types of optical recording media;
a third light source emitting third light beams with a third wavelength greater than said second wavelength for the other of said three types of optical recording media;
an objective lens adapted for receiving said first, second and third light beams from said first, second and third light sources so as to focusing said first, second and third light beams onto each of said three types of optical recording media respectively; and
a prism unit disposed between said objective lens and each of said first, second and third light sources so as to transmit said first, second and third light beams therebetween, said prism unit being capable of accepting said first, second and third light beams from said first, second and third light sources for transmission in a common plane, and locations, where said first, second and third light beams are capable of passing therethrough in said common plane, being arranged as non-linear.

18. The information recording and reproducing apparatus according to claim 17, wherein said common plane is defined along a substrate where said first, second and third light sources are integrally disposed thereon.

19. The information recording and reproducing apparatus according to claim 17, further comprising a receiving member located in said common plane for receiving and verifying said first, second and third light beams returned from said each of said three types of optical recording media respectively.

20. The information recording and reproducing apparatus according to claim 17, wherein said prism unit comprises a first prism extending along a first direction, and a second prism arranged beside said first prism and extending along a second direction perpendicular to said first direction so as to allow said first and second light beams passing through both of said first and second prisms, said second light beams passing through said first prism mainly along said first direction before entering said second prism, and said third light beams passing through said second prism exclusively.
